(19) United States
(12) Patent Application Publication
(10) Pub. No.: US 2026/0106497 A1
(43) Pub. Date: Apr. 16, 2026

(54) STATOR FOR ROTATING ELECTRIC MACHINE

(71) Applicant: HONDA MOTOR CO., LTD., Tokyo (JP)

(72) Inventors: Keisuke AZUSAWA, Saitama (JP); Yoshihisa KUBOTA, Saitama (JP)

(21) Appl. No.: 19/353,752

(22) Filed: Oct. 9, 2025

(30) Foreign Application Priority Data
Oct. 15, 2024 (JP) 2024-180414

(51) Int. Cl. H02K 1/16; H02K 3/12

(52) U.S. Cl. CPC H02K 1/16; H02K 3/12

(57) ABSTRACT

A stator for a rotating electric machine (a two-phase motor) includes: a stator core including a plurality of slots each extending in a radial direction and disposed in a circumferential direction; and a coil including a plurality of parallel coils (a β1 coil and a β2 coil) per phase, and wound in the circumferential direction to pass through a plurality of turns in the plurality of slots. The slot includes a first slot in which only one parallel coil (the β1 coil or the β2 coil) is wound, and a second slot, which is disposed at a predetermined circumferential position different from the first slot, and in which the plurality of parallel coils that are both present and wound.

### BACKGROUND

### Technical Field

The present invention relates to a stator for a rotating electric machine used as an electric motor or a generator.

### Related Art

In recent years, research and development on downsizing, weight reduction, yield improvement, and the like that contribute to energy efficiency have been conducted so that more people are able to access affordable, reliable, sustainable, and advanced energy. For example, an electric vehicle (EV) uses only a motor as a power source, and thus has an advantage of not discharging carbon dioxide, nitrogen oxides, or the like during traveling, and is expected as an automobile of a next generation. Therefore, techniques related to improvement in energy efficiency of a motor mounted on an electric vehicle or the like are being developed. Examples of such techniques include a rotating electric machine disclosed in JP 3621635 B2.

### Citation List

### Patent Literature

Patent Literature 1: JP 3621635 B2

### SUMMARY

In the above-described rotating electric machine, an end portion of the winding end of the armature winding wound around an armature core is inserted into the turn of an innermost diameter of a slot. For this reason, in the above-described rotating electric machine, in order to connect the end portion of the winding end of the armature winding to a drive circuit, it is necessary to use a complicated and long bus bar from the turn of the innermost diameter of the slot to the outside of the armature core and pull out the end portion.

The above-described rotating electric machine, however, has such a structure, and thus stress applied to such a bus bar due to vibration or the like is amplified by the principle of leverage, and may be applied to a part in which the end portion of the winding end of the armature winding and the bus bar are welded together. In addition, since the above-described rotating electric machine necessitates the complicated and long bus bar, thereby necessitating lots of materials for producing the bus bar, lowering the yield of the bus bar, and making the downsizing difficult.

The present invention has been made to solve the above problems, and it is an object of the present invention to provide a stator for a rotating electric machine, in which a bus bar for pulling out a coil to the outside of a stator core can be shortened and simplified, and more favorable operation particularly at the time of charging is achievable. In addition, the present invention contributes to improvement in energy efficiency, accordingly.

In order to achieve the above object, according to a first aspect, a stator 2 for a rotating electric machine (a two-phase motor 1), the stator 2 includes: a stator core 4 including a plurality of slots 7 each extending in a radial direction and disposed in a circumferential direction; and a coil 5 including a plurality of parallel coils (for example, a β1 coil and a β2 coil) per phase, and wound in the circumferential direction to pass through a plurality of turns in the plurality of slots 7, wherein the slot 7 includes a first slot 7A in which only one parallel coil (the β1 coil or the β2 coil) of the plurality of parallel coils is wound, and a second slot 7B which is disposed at a predetermined circumferential position different from the first slot 7A, and in which the plurality of parallel coils that are both present and wound.

According to this configuration, for example, it becomes possible to wind, for example, one parallel coil in one direction from the turn of an outermost diameter to the turn of an innermost diameter of the slot, then reverse the direction via the bus bar, and wind to the turn of the outermost diameter in the opposite direction. In this manner, it is sufficient if the bus bar is provided only on the inner diameter side of the slot. Unlike the conventional case, the complicated and long bus bar for guiding the coil from the inner diameter side of the slot to the outside of the stator core is no longer necessary. This enables a reduction of the material necessary for producing the bus bar, improvement in the yield of the bus bar, and downsizing of the bus bar.

In addition, according to the above configuration, when the reverse phase energization is conducted for reversing the direction of the electric current of one parallel coil and the direction of the electric current of the other parallel coil in one phase to be opposite to each other, the magnetic flux generated in one parallel coil and the magnetic flux generated in the other parallel coil can be prevented from interfering with each other, so that the inductance can be improved.

According to a second aspect, in the stator for the rotating electric machine described in the first aspect, the first slot 7A and the second slot 7B may be alternately disposed in the circumferential direction for every pole.

According to this configuration, the pitch of the parallel coils inserted into the first slot 7A and the second slot 7B and the pitch of the coil for joining the end portions of the parallel coils can be made constant, and their configurations can be simplified.

In addition, when the reverse phase energization is conducted on the two parallel coils, the magnetic flux that passes through the first slot of one parallel coil and the magnetic flux that passes through the first slot of the other parallel coil are generated, and the number of poles of the stator is reduced, and can be unmatched with the number of poles of the rotor. Due to such an unmatched situation of the number of poles, even though the magnetic flux is generated by AC current supplied at the time of charging, no torque is generated in the rotor, so that the torque at the time of charging can be made zero.

According to a third aspect, in the stator for the rotating electric machine described in the first aspect, the rotating electric machine may have a two-phase configuration including an α phase and a β phase, and may be configured to be a generator using an inverter and charging a battery from an external power supply, and a slot for the α phase may include only a second slot 2B in which an α1 coil and an α2 coil as the plurality of parallel coils are both present, a slot for the β phase may include a first slot 7A in which either a β1 coil or a β2 coil only is present and a second slot 7B in which the β1 coil and the β2 coil as the plurality of parallel coils are both present, and the first slot 7A and the second slot 7B for the β phase may be alternately disposed in the circumferential direction for every pole.

According to this configuration, in the α phase in which the slot is constituted of only the second slot in which the α1 coil and the α2 coil are both present, the voltage is easily adjusted at the time of charging by lowering the inductance. On the other hand, in the β phase constituted of the first slot in which only the β1 coil or the β2 coil is present and the second slot in which the β1 coil and the β2 coil are both present, the inductance can be improved by, for example, the reverse phase energization, so that a loss of power factor improvement at the time of charging can be reduced. In this manner, it becomes possible to selectively use a phase in which the inductance is desired to be improved and a phase in which the inductance is desired to be lowered, so that the charging quality can be improved.

### BRIEF DESCRIPTION OF DRAWINGS

FIG. 1 is a diagram illustrating an example of a winding method, arrangement of coils, and joining by use of a bus bar, in a stator for a two-phase motor according to an embodiment of the present invention;

FIG. 2 is a diagram illustrating operation of the two-phase motor; and

FIG. 3 is a diagram illustrating a connection state of a coil to an inverter circuit.

### DETAILED DESCRIPTION

Hereinafter, embodiments of the present invention will be described with reference to the drawings. In the present embodiment, an example of using a two-phase motor as a rotating electric machine will be described. A two-phase motor 1 is mounted on, for example, an electric vehicle, and is used as an electric motor for actuating wheels and as a generator for generating electric power by using dynamic power of the wheels.

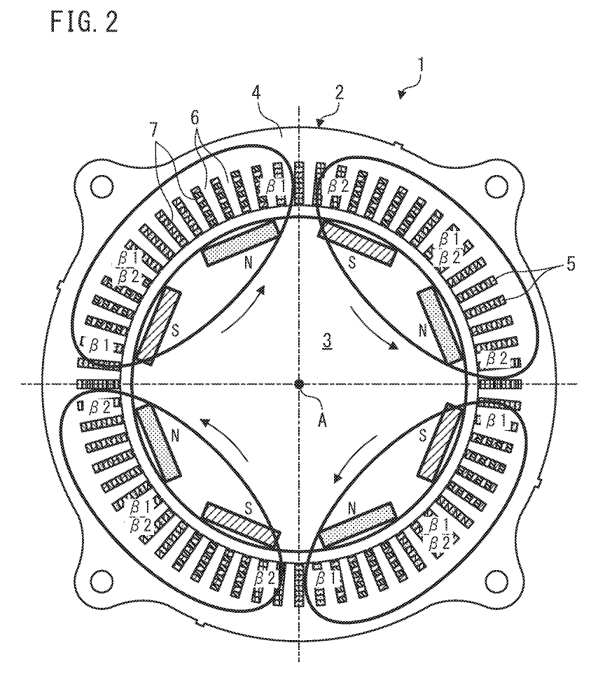

As illustrated in FIG. 2, the two-phase motor 1 includes a stator 2 and a rotor 3. The stator 2 includes a stator core 4 and a coil 5. The rotor 3 includes eight permanent magnets disposed so that the magnetic poles are alternately reversed.

The stator core 4 is a cylindrical member, and a large number of teeth 6 and slots 7 are disposed inside the stator core 4 to be aligned in a circumferential direction. The teeth 6 are parts each extending in a radial direction toward a rotation axis A of the rotor 3 in the stator core 4, and the shape and dimension of a cross-section orthogonal to the rotation axis A are constant regardless of the position in an axial direction. The slot 7 is a space defined between two adjacent teeth 6, and thus extends in the radial direction toward the rotation axis A similarly to the teeth 6, and the shape and dimension of the cross-section orthogonal to the rotation axis A are constant regardless of the position in the axial direction.

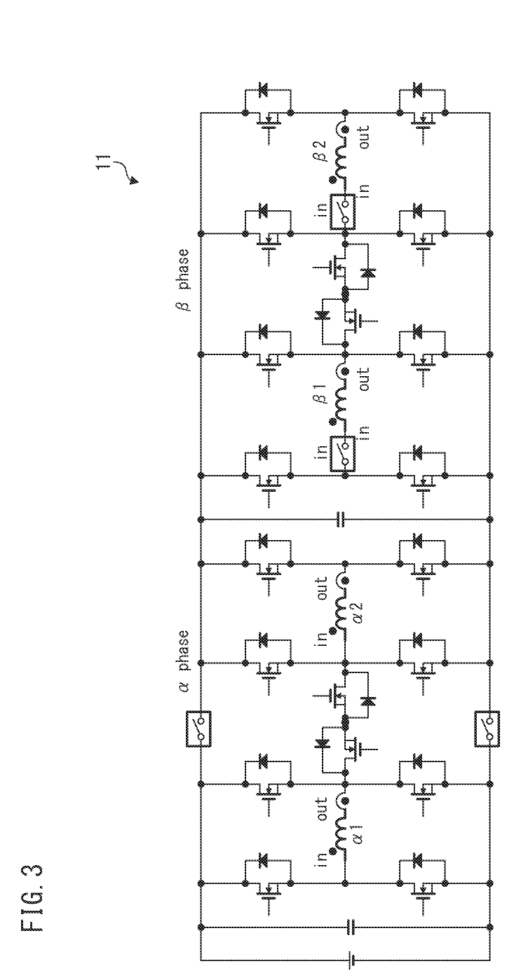

The coil 5 is a wire wound around the teeth 6. Specifically, the coil 5 is wound in the entirety of the stator core 4 by repeating a structure in which end portions of an alphabetical letter U-shaped rectangular wire inserted into two slots 7 are electrically joined to other end portions of the alphabetical letter U-shaped rectangular wire. The coil 5 is open winding, both ends of which are connected with and incorporated in inverter circuits 11 (see FIG. 3). With this configuration, in a case where the two-phase motor 1 is used as an electric motor, the coil 5 generates magnetic force for rotating the rotor 3 around the rotation axis A in accordance with energization by the inverter circuit 11, and in a case where the two-phase motor 1 is used as a generator, the coil 5 generates electric current for generating the electric power in accordance with rotation of the rotor 3 and a change in a peripheral magnetic field.

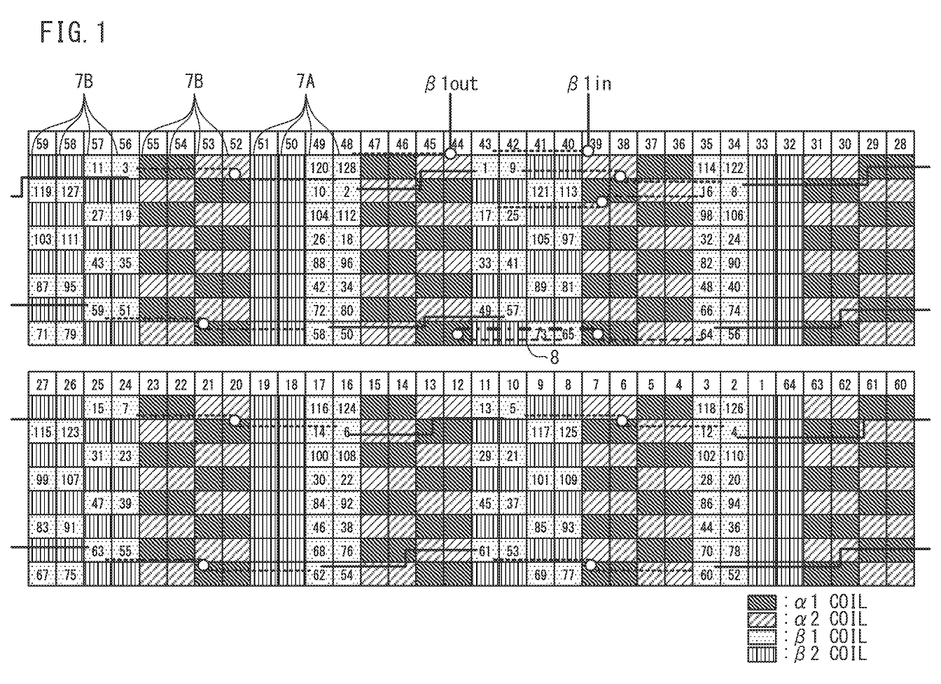

FIG. 1 illustrates an example of a winding method of the coil 5 and joining by use of a bus bar 8. In this example, the two-phase motor 1 has an α phase and a β phase, and one pole of each phase includes four slots 7. Therefore, the two-phase motor 1 includes: a coil α1 and a coil α2, which constitute the α phase, and which are in parallel with each other; and a coil β1 and a coil β2, which constitute the β phase, and which are in parallel with each other. Note that FIG. 1 mainly illustrates an example of a winding method of the coil β1 and joining by use of the bus bar 8.

Each square in the first row from the top in FIG. 1 indicates a slot number allocated to each slot 7 of the stator core 4. As illustrated in the first row from the top in FIG. 1, 64 slots 7 are formed in the stator core 4. Each square in the second to ninth rows from the top in FIG. 1 indicates a position in which one of the end portions of the letter U-shaped rectangular wire is inserted in each slot 7. The position numbers written in these squares respectively indicate the sequential order in which the rectangular wire that constitutes the coil of each phase (the coil β1 in FIG. 1) passes.

As illustrated in FIG. 1, a square hatched with dark oblique lines indicates a position into which the rectangular wire that constitutes the coil α1 is inserted, and a square hatched with light oblique lines indicates a position into which the rectangular wire that constitutes the coil α2 is inserted. In addition, a square hatched with dots indicates a position into which the rectangular wire that constitutes the coil β1 is inserted, and a square hatched with vertical lines indicates a position into which the rectangular wire that constitutes the coil β2 is inserted.

The second to ninth rows from the top in FIG. 1 respectively indicate the first to eighth turns from an outer diameter side to an inner diameter side of the stator core 4. The term “turn” used herein refers to each of 64 squares located at a certain distance from the outer diameter side of the stator core 4 in the radial direction of a circle with a point on the rotation axis A as the center and located on a plane orthogonal to the rotation axis A.

In addition, a solid line illustrated in FIG. 1 indicates that a curved part of the letter U-shaped rectangular wire protrudes in a direction from the depth to the front on the sheet surface of FIG. 1. On the other hand, a dotted line illustrated in FIG. 1 indicates that the end portion of the letter U-shaped rectangular wire protrudes in a direction from the depth to the front on the sheet surface of FIG. 1. A dash-dot line in FIG. 1 indicates the bus bar 8, which electrically joins the end portions of the rectangular wires together. A white circle in FIG. 1 indicates a part in which the end portions or the like of the rectangular wires are welded together to be electrically joined together.

Hereinafter, the winding method of the coil β1 and joining by use of the bus bar 8 will be specifically described with reference to FIG. 1.

As illustrated in FIG. 1, an end portion β1in of the winding start of the coil β1 is electrically joined to an end portion of the rectangular wire inserted into the first turn, which is the turn of the outermost diameter of the slot number 43 in the vicinity of the position of the first turn of the slot number 39, which is hatched with the light oblique lines.

The coil β1 includes a rectangular wire in which one end portion disposed on the right side slot 7 in FIG. 1 is inserted into the position of the position number 1 of the first turn and the other end portion disposed on the left side slot 7 in FIG. 1 is inserted into the position of the position number 2 of the second turn. The coil β1 includes a rectangular wire in which one end portion disposed on the right side slot 7 in FIG. 1 is inserted into the position of the position number 3 of the first turn, and is also electrically joined to the end portion of the rectangular wire inserted into the position of the position number 2, and the other end portion disposed on the left side slot 7 in FIG. 1 is inserted into the position of the position number 4 of the second turn.

The coil β1 includes a rectangular wire in which one end portion disposed on the right side slot 7 in FIG. 1 is inserted into the position of the position number 5 of the first turn, and is also electrically joined to the end portion of the rectangular wire inserted into the position of the position number 4, and the other end portion disposed on the left side slot 7 in FIG. 1 is inserted into the position of the position number 6 of the second turn. The coil β1 includes a rectangular wire in which one end portion disposed on the right side slot 7 in FIG. 1 is inserted into the position of the position number 7 of the first turn, and is also electrically joined to the end portion of the rectangular wire inserted into the position of the position number 6, and the other end portion disposed on the left side slot 7 in FIG. 1 is inserted into the position of the position number 8 of the second turn.

As described above, the coil β1 is wound in the first turn and the second turn of the slot 7 using the above-described four rectangular wires. The coil β1 is further wound in the direction from the right to the left in FIG. 1 from the third turn to the eighth turn of an innermost diameter of the slot 7 in a similar configuration, and the end portion of the last rectangular wire is inserted into the position of the position number 64, which corresponds to the eighth turn of the slot number 35. As described above, the coil β1 is wound in the direction from the right to the left in FIG. 1 from the winding start position to the position of the position number 64 (hereinafter, this part will be referred to as a “forward winding portion”).

In addition, as will be described later, the coil β1 is wound in the direction from the left to the right in FIG. 1 from the position of the position number 65 of the eighth turn of the slot number 40, which is shifted to the left by five from the position number 64, to the winding end position of the first turn (hereinafter, this part will be referred to as a “reverse winding portion”).

The bus bar 8 electrically joins an end point of the forward winding portion and a start point of the reverse winding portion of the coil β1 at the eighth turn of the innermost diameter of the slot 7. Specifically, the bus bar 8 is electrically joined to the end portion of the rectangular wire inserted into the position of the position number 64 of the eighth turn of the slot number 35 and the end portion of the rectangular wire inserted into the position of the position number 65 of the eighth turn of the slot number 40. Note that the bus bar 8 is indicated by the dash-dot line in FIG. 1.

Hereinafter, a winding method in the reverse winding portion of the β1 coil will be described. The coil β1 includes a rectangular wire in which an end portion disposed on the left side slot 7 in FIG. 1 is inserted into the position of the position number 65 of the eighth turn and an end portion disposed on the right side slot 7 in FIG. 1 is inserted into the position of the position number 66 of the seventh turn. The coil β1 includes a rectangular wire in which an end portion disposed on the left side slot 7 in FIG. 1 is inserted into the position of the position number 67 of the eighth turn, and is electrically joined to the end portion of the rectangular wire inserted into the position of the position number 66, and an end portion disposed on the right side slot 7 in FIG. 1 is inserted into the position of the position number 68 of the seventh turn.

The coil β1 includes a rectangular wire in which an end portion disposed on the left side slot 7 in FIG. 1 is inserted into the position of the position number 69 of the eighth turn, and is electrically joined to the end portion of the rectangular wire inserted into the position of the position number 68, and an end portion disposed on the right side slot 7 in FIG. 1 is inserted into the position of the position number 70 of the seventh turn. The coil β1 includes a rectangular wire in which an end portion disposed on the left side slot 7 in FIG. 1 is inserted into the position of the position number 71 of the eighth turn, and is electrically joined to the end portion of the rectangular wire inserted into the position of the position number 70, and an end portion disposed on the right side slot 7 in FIG. 1 is inserted into the position of the position number 72 of the seventh turn.

As described above, in the reverse winding portion, the coil β1 is wound in the eighth turn and the seventh turn of the slot 7 using the above-described four rectangular wires. The coil β1 is further wound in the direction from the left to the right in FIG. 1 from the sixth turn to the first turn of the stator core in a similar configuration, and the end portion of the last rectangular wire is inserted into the position of the position number 128, which corresponds to the first turn of the slot number 48.

As illustrated in FIG. 1, an end portion β1out of the winding end of the coil β1 is electrically joined to the end portion of the last rectangular wire inserted into the position of the position number 128 in the vicinity of the position of the first turn of the slot number 44, which is hatched with light oblique lines.

The coil β2, the coil α1, and the coil α2 are wound in a similar manner to the coil β1, and a specific winding method is as follows. As described above, the position of the slot 7 in which the coil β2 is wound is indicated by a square hatched with the vertical lines in FIG. 1. The end portion of the rectangular wire at the winding start of the coil β2 is inserted into a predetermined position of the first turn of the outermost diameter of the slot 7, and the coil β2 is wound from this position as a start point to a predetermined position of the eighth turn of the innermost diameter of the slot 7 in the direction from the right to the left in FIG. 1 in a similar winding method to the coil β1 (the forward winding portion). In addition, the winding direction of the coil β2 is reversed by a bus bar (not illustrated) similarly to the coil β1, and the coil β2 is wound to a predetermined position of the first turn of the outermost diameter of the slot 7 in the direction from the left to the right in FIG. 1 (the reverse winding portion).

The position of the slot 7 in which the coil α1 is wound is indicated by a square hatched with dark oblique lines in FIG. 1. The end portion of the rectangular wire at the winding start of the coil α1 is inserted into a predetermined position of the first turn of the outermost diameter of the slot 7, and the coil α1 is wound from this position as a start point to a predetermined position of the eighth turn of the innermost diameter of the slot 7 in the direction from the right to the left in FIG. 1 in a similar winding method to the coil β1. In addition, the winding direction of the coil α1 is reversed by a bus bar (not illustrated), and the coil α1 is wound to a predetermined position of the first turn of the outermost diameter of the slot 7 in the direction from the left to the right in FIG. 1.

The position of the slot 7 in which the coil α2 is wound is indicated by a square hatched with the light oblique lines in FIG. 1. The end portion of the rectangular wire at the winding start of the coil α2 is inserted into a predetermined position of the first turn of the outermost diameter of the slot 7, and the coil α2 is wound from this position as a start point to a predetermined position of the eighth turn of the innermost diameter of the slot 7 in the direction from the right to the left in FIG. 1 in a similar winding method to the coil β1. In addition, the winding direction of the coil α2 is reversed by a bus bar (not illustrated), and the coil α2 is wound to a predetermined position of the first turn of the outermost diameter of the slot 7 in the direction from the left to the right in FIG. 1.

As a result of the four parallel coils (the coil α1, the coil α2, the coil β1, and the coil β2) that are wound in the slots 7 of the stator 2 as described above, the arrangement (distribution) of the parallel coils in all the slots 7 is as illustrated in FIG. 1. Hereinafter, the arrangement of the parallel coils will be described.

First, as illustrated in FIG. 1, one pole of one phase (α phase or β phase) of the coil 5 is constituted of four slots 7 (for example, the slot numbers 28 to 31 or the slot numbers 32 to 35), and four slots 7, which constitute α-phase pole, and four slots 7, which constitute β-phase pole, are alternately disposed in the circumferential direction over the entirety of the stator 2. In addition, the slots 7 are individually classified into the slot 7 (hereinafter, referred to as a “first slot 7A” as appropriate) in which only one parallel coil (the β1 coil or the β2 coil) is wound and the slot 7 (hereinafter, referred to as a “second slot 7B” as appropriate) in which two parallel coils (the α1 coil and the α2 coil or the β1 coil and the β2 coil) of the same phase are alternately disposed from the first turn to the eighth turn.

According to the above definition, as illustrated in the upper part of FIG. 1, the arrangement of the coil 5 in the slots 7 in the range of the slot numbers 28 to 59 is as follows.

### Slot Number

28, 29 ... α1 and α2 coils

30, 31 ... α1 and α2 coils (in a zigzag pattern for the slot numbers 28 and 29)

32, 33 ... β2 coil only

34, 35 ... β1 coil only

36, 37 ... α1 and α2 coils (same as the slot numbers 28 and 29)

38, 39 ... α1 and α2 coils (same as the slot numbers 30 and 31)

40, 41 ... β1 and β2 coils

42, 43 ... β1 and β2 coils (in a zigzag pattern for the slot numbers 40 and 41)

44, 45 ... α1 and α2 coils (same as the slot numbers 30 and 31)

46, 47 ... α1 and α2 coils (same as the slot numbers 28 and 29)

48, 49 ... β1 coil only

50, 51 ... β2 coil only

52, 53 ... α1 and α2 coils (same as the slot numbers 30 and 31)

54, 55 ... α1 and α2 coils (same as the slot numbers 28 and 29)

56, 57 ... β1 and β2 coils (same as the slot numbers 42 and 43)

58, 59 ... β1 and β2 coils (same as the slot numbers 40 and 41)

As described above, the slot 7 for the α phase is constituted of only the second slot 7B in which the α1 coil and the α2 coil are both present, and the slot 7 for the β phase is constituted of the first slot 7A in which only the β1 coil or the β2 coil is present, and the second slot 7B in which the β1 coil and the β2 coil are both present.

In addition, as illustrated in the lower part of FIG. 1, the arrangement of the coil 5 in the slots 7 in the range of the slot numbers 60 to 27, which are shifted in the circumferential direction by 180 degrees with respect to the slot numbers 28 to 59, is similar to the above-described arrangement in the slot numbers 28 to 59.

As described heretofore, according to the present embodiment, the α1 coil and the α2 coil, which are the parallel coils of the α phase, and the β1 coil and the β2 coil, which are the parallel coils of the β phase, are wound in one direction from the first turn of the outermost diameter to the eighth turn of the innermost diameter of the slot 7, and then reversed via the bus bar 8, and are wound in the opposite direction from the eighth turn to the first turn of the outermost diameter. In this manner, it is sufficient if the bus bar is provided only on the inner diameter side of the slot 7. Unlike the conventional case, the complicated and long bus bar for guiding the coil 5 from the inner diameter side of the slot 7 to the outside of the stator core 4 is no longer necessary. This enables a reduction of the material necessary for producing the bus bar, improvement in the yield of the bus bar, and downsizing of the bus bar.

In addition, the slot 7 in which the coil 5 of β phase is wound is constituted of a first slot 7A (for example, the slot numbers 32 to 35) in which only the β1 coil or the β2 coil is wound, and a second slot 7B (for example, the slot numbers 40 to 43) in which the β1 coil and the β2 coil are alternately wound. With this configuration, when reverse phase energization is conducted for reversing the direction of the electric current of the β1 coil and the direction of the electric current of the β2 coil to be opposite to each other, the magnetic flux generated in the β1 coil and the magnetic flux generated in the β2 coil can be prevented from interfering with each other as illustrated in FIG. 2, so that the inductance can be improved.

Furthermore, four first slots 7A and four second slots 7B for the β phase are disposed at equal intervals on both sides of the four slots 7 for the α phase. With this configuration, the pitch of the rectangular wires inserted into the first slot 7A and the second slot 7B and the pitch of the coil for joining the end portions of the two rectangular wires can be made constant, and their configurations can be simplified.

In addition, when the reverse phase energization is conducted on the β1 coil and the β2 coil, two magnetic fluxes that pass through the first slot 7A of the β1 coil and two magnetic fluxes that pass through the first slot 7A of the β2 coil are generated as illustrated in FIG. 2, and the stator 2 has four poles. On the other hand, the rotor 3 has eight poles, and thus the numbers of poles are unmatched. Due to such an unmatched situation of the number of poles, even though the magnetic flux is generated by AC voltage supplied at the time of charging, no torque is generated in the rotor 3, so that the torque at the time of charging can be made zero.

In addition, in the α phase in which the slot 7 is constituted of only the second slot 7B, in which the α1 coil and the α2 coil are both present, the voltage is easily adjusted at the time of charging by lowering the inductance. On the other hand, in the β phase constituted of the first slot 7A in which only the β1 coil or the β2 coil is present and the second slot 7B in which the β1 coil and the β2 coil are both present, the inductance can be improved by, for example, the reverse phase energization, so that a loss of power factor improvement at the time of charging can be reduced. In this manner, it becomes possible to selectively use a phase in which the inductance is desired to be improved and a phase in which the inductance is desired to be lowered, so that the charging quality can be improved.

Note that in the above-described embodiments, the case where the rotating electric machine according to an embodiment is a two-phase motor has been described as an example. However, without being limited to this, for example, a three-phase motor may be applicable. Additionally, the present invention is not limited to the above-described embodiments. That is, the present invention includes embodiments subjected to various modifications, substitutions, design changes, and the like based on the gist of the present invention, and does not exclude these embodiments.

What is claimed is:

1. A stator for a rotating electric machine, the stator comprising:
a stator core including a plurality of slots each extending in a radial direction and disposed in a circumferential direction; and
a coil including a plurality of parallel coils per phase, and wound in the circumferential direction to pass through a plurality of turns in the plurality of slots, wherein
the slot includes a first slot in which only one parallel coil of the plurality of parallel coils is wound, and a second slot which is disposed at a predetermined circumferential position different from the first slot, and in which the plurality of parallel coils that are both present and wound.

2. The stator for the rotating electric machine according to claim 1, wherein the first slot and the second slot are alternately disposed in the circumferential direction for every pole.

3. The stator for the rotating electric machine according to claim 1, wherein
the rotating electric machine has a two-phase configuration including an α phase and a β phase, and is configured to be a generator using an inverter and charging a battery from an external power supply, and
a slot for the α phase includes only a second slot in which an α1 coil and an α2 coil as the plurality of parallel coils are both present, a slot for the β phase includes a first slot in which either a β1 coil or a β2 coil only is present and a second slot in which the β1 coil and the β2 coil as the plurality of parallel coils are both present, and the first slot and the second slot for the β phase are alternately disposed in the circumferential direction for every pole.
